(19) United States
(12) Patent Application Publication
(10) Pub. No.: US 2002/0182923 A1
(43) Pub. Date: Dec. 5, 2002

(54) Portable input device with locking function

(76) Inventors: Chin-Chen Li, Shinjuang City (TW); Hui-Hsiung Hsu, Guanyin Shiang (TW); Jian-Ying Liau, Shiluo Jen (TW)

Correspondence Address: SNELL & WILMER, ONE ARIZONA CENTER, 400 EAST VAN BUREN, PHOENIX, AZ, 850040001

(21) Appl. No.: 10/142,035

(22) Filed: May 9, 2002

(30) Foreign Application Priority Data
May 29, 2001 (TW) 090112878

(51) Int. Cl. H01R 13/627

(52) U.S. Cl. 439/357

(57) ABSTRACT

The present invention relates to a portable input device, such as a portable keyboard, with a locking apparatus, which connects the portable input device with an electronic device. The portable input device of the present invention includes a casing and a locking apparatus on the casing. The locking apparatus further includes a latch to buckle the portable input device with the electronic device. The present invention improves connection between the portable input device and the electronic device to prevent the portable input device from detaching from the electronic device during operation.

This application claims priority of Taiwan Patent Application Serial No. 90112878 filed on May 29, 2001.

### FIELD OF INVENTION

The present invention relates to a portable input device, and more particularly, to a portable input device lockably connecting to an electronic device.

### BACKGROUND OF THE INVENTION

Since the advent of portable computers, more and more computer equipment of smaller size has been introduced in the market. As the size of such computers reduces, however, smaller input/output devices become increasingly in demand. Due at least in part to the inconvenience of using small input/output devices, many portable devices have not yet become as popular as originally expected. Accordingly, there is a trade-off between convenience and ease-of-use for portable electronic instruments.

Personal Digital Assistant (PDAs) such as those available from Palm, Handspring, Sony, Hewlett-Packard and others have become increasingly popular. Such PDAs typically have liquid crystal displays and, unlike conventional computers, are not typically equipped with conventional keyboards. Several conventional techniques exist for inputting data to a PDA. For example, many devices receive input information on a display panel by use of the pen input device or stylus to input data. Handwriting information from the user is typically stored as a bitmap, however, which takes up a relatively large amount of memory space and frequently degrades the performance of the PDA. Alternatively, many devices include a handwriting recognition software that changes handwriting information into ASCII or other codes that can be readily stored and processed. In some cases, the PDA has a virtual keyboard that is displayed on the display area whereby the user inputs data by selecting keys on the virtual keyboard using the pen stylus.

However, data input rates and responses of many PDA input processes are slow and insensitive compared with conventional keyboards. External keyboards have therefore been proposed as input devices for PDAs. When such external keyboards are not in use, the keyboard is detached from the PDA to improve portability and convenience. When data is being input with the external keyboard, the keyboard is typically connected to the PDA to improve input speed and comfortablility.

There are two kinds of the conventional separable keyboard. One is the QWERTY keyboard for desktop applications, which is usually connected to an electronic device with a PDA holder. Another type is a separable PDA keyboard that is smaller than a conventional keyboard and has fewer keys. The separable PDA keyboard is connected to a electronic device and is held by a user's hand while he/she performs an input action.

Nevertheless, many tiny electronic devices do not have proper holders, thus resulting in inconvenient operation as electronic device and an associated input device detach from each other during use, or the like.

To solve problems mentioned above, a portable input device with a locking function is desired such that a user can quickly perform the input operation to the electronic device.

### SUMMARY OF THE INVENTION

The present invention discloses a portable input device, such as a keyboard, used for lockably connecting to an electronic device, such as a PDA or a mobile phone. The portable input device includes a body and a locking unit. The locking unit, which is disposed on the input unit, includes a latch. The latch is made by an elastic material or the latch is connected to an elastic unit for providing deformation capability along the locking direction. When the electronic device is locked with the portable input device, the latch moves along a guiding unit in the electronic device. The latch is locked with the electronic device while moving into a locking position.

The latch may be substituted by a cap-shaped unit for locking with the electronic device. Moreover, the locking unit may be disposed on the portable input device or integrated with a connector of the portable input device. When the portable input device connects to the electronic device, the connector also connects to the electronic device.

### BRIEF DESCRIPTION OF THE DRAWINGS

FIG. 1 is a schematic diagram of an exemplary embodiment of the present invention showing that the portable input device is connected to an electronic device.

FIGS. 2A and 2B illustrate a first exemplary embodiment of the present invention.

FIGS. 3A and 3B illustrate a second exemplary embodiment of the present invention.

FIGS. 4A and 4B illustrate a third exemplary embodiment of the present invention.

FIGS. 5A and 5B illustrate a fourth exemplary embodiment of the present invention.

### DETAILED DESCRIPTION

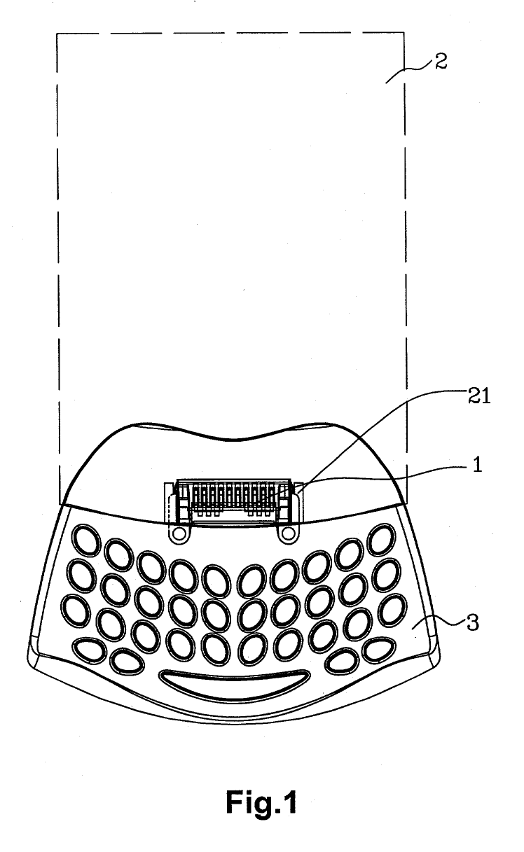

FIG. 1 is a schematic diagram showing a portable input device 3 connected to an electronic device 2. The locking apparatus includes a locking unit 1 disposed on portable input device 3 and a guiding unit 21 disposed on electronic device 2. The portable input device 3 may be a portable keyboard, a portable writing pad, a touchpad, a microphone for voice input, or any other portable input device. Electronic device 2 may be a PDA, a mobile phone, a global positioning system, or any other hand-held electronic device.

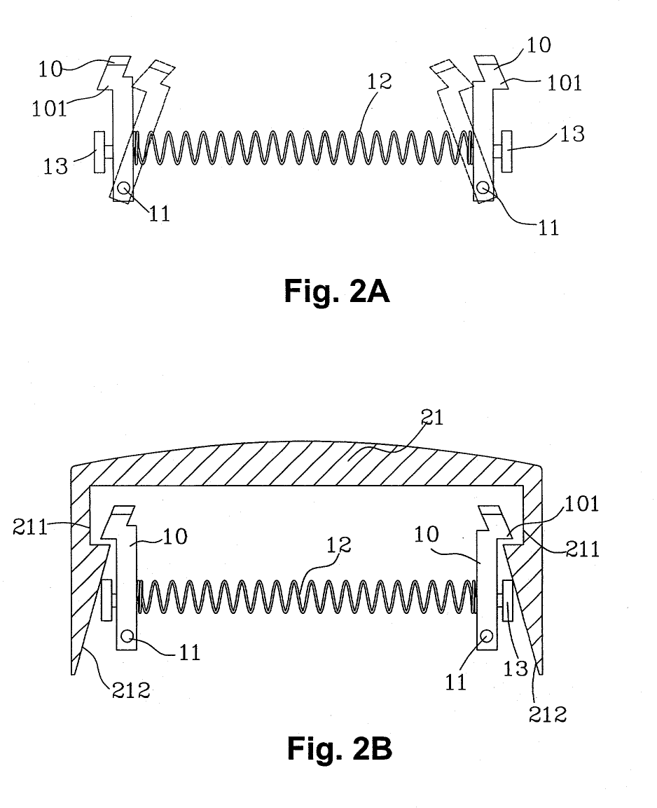

FIG. 2A is a schematic diagram showing a locking unit 1 disposed in portable input device 3. In the first exemplary embodiment, locking unit 1 includes a latch 10, a pivot 11, an elastic unit 12 and a button 13. Pivot 11 connects latch 10 to portable input device 3, and latch 10 suitably rotates around pivot 11 as shown by the dotted line. Latch 10 has a protrusion 101 whose shape corresponds to a slot 211 of a guiding unit 21 of electronic device 2 shown in FIG. 2B. Referring now to FIG. 2A, the two latches 10 connect to each other by an elastic unit 12 which is initially in a compressed state. The elastic unit 12 may be a spring or other similar biasing device. The elastic force of elastic unit 12 biases the two latches 10 apart from each other. Latch 10 in this embodiment may include a button 13 that the user pushes to control the position of latch 10.

Please refer to FIG. 2B. When a user wants to connect electronic device 2 to the portable input device 3, he/she pushes buttons 13 to exert a force on latches 10. The distance between the two latches 10 is thereby shortened, and latches 10 are delivered into a space formed by guiding unit 21. Guiding unit 21 of electronic device 2 has guiding surfaces 212, and the latches 10 respectively slide along the guiding surfaces 212 of the guiding unit 21. Because of the shape of guiding unit 21, latches 10 are pressed closer to each other while protrusions 101 slide along guiding surfaces 212. Latches 10 connect to each other by an elastic unit 12. The elastic unit 12 is compressed and shortened while latches 10 are pressed closer to each other by guiding surfaces 212. As protrusion 101 is pushed to a position corresponding to slot 211 of the guiding unit, protrusion 101 is driven into the slot 211 by an outward elastic force of elastic unit 12. At the end, electronic device 2 is locked with portable input device 3.

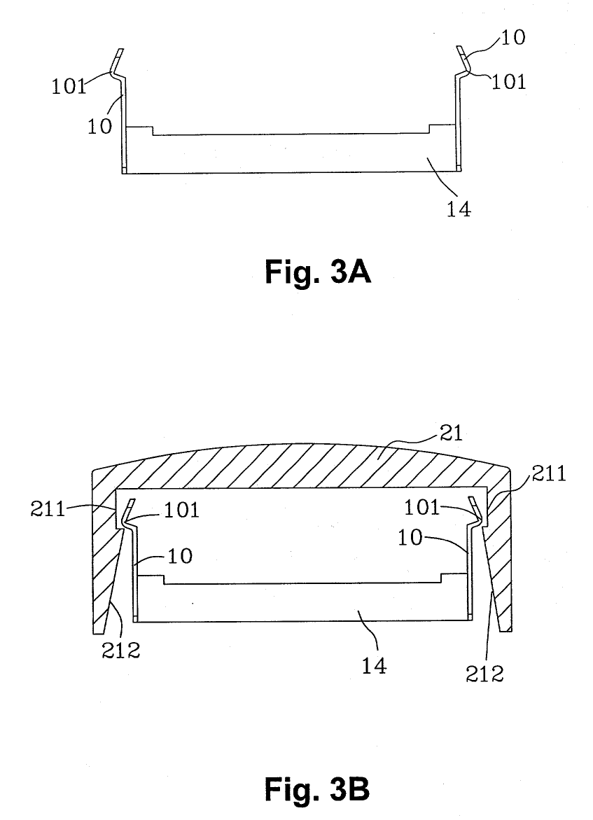

FIG. 3A is a schematic diagram showing locking unit 1 of portable input device 3 in a second exemplary embodiment. Locking unit 1 includes a latch 10 and a supporter 14. The latch 10 has a protrusion 101, whose shape corresponds to a slot 211 of a guiding unit 21 of an electronic device 2 as shown in FIG. 3B. Part of latch 10 close to protrusion 101 is made by an elastic material. While latch 10 slides along the guiding surface 212 of guiding unit 21, protrusion 101 slightly changes its shape to mate with the shape of guiding surface 212. After the protrusion 101 of latch 10 is locked with slot 211, protrusion 101 returns to the original shape. Finally, portable input device 3 is locked with electronic device 2. In this second exemplary embodiment latches 10 connect to each other by a supporter 14 that is used for maintaining the horizontal distance between two latches 10 to prevent latches 10 from undesirably detaching guiding unit 21. Supporter 14 is also used to connect latches 10 and portable input device 3.

Please refer to FIG. 3B. When a user connects electronic device 2 to the portable input device 3, he/she aligns locking unit 1 to guiding unit 21. The latches 10 are delivered into guiding unit 21 and slide along the guiding surfaces 212. Because of the shape of guiding surface 212 latches 10 are pressed to be closer to each other while protrusions 101 slide along guiding surfaces 212. Protrusions 101 of latches 10 are made of an elastic material to deform slightly when pressed by guiding surface 212 of guiding unit 21. As protrusion 101 is pushed to a position corresponding to slot 211, protrusions 101 recover and are driven into slot 211 to thereby lock electronic device 2 with portable input device 3.

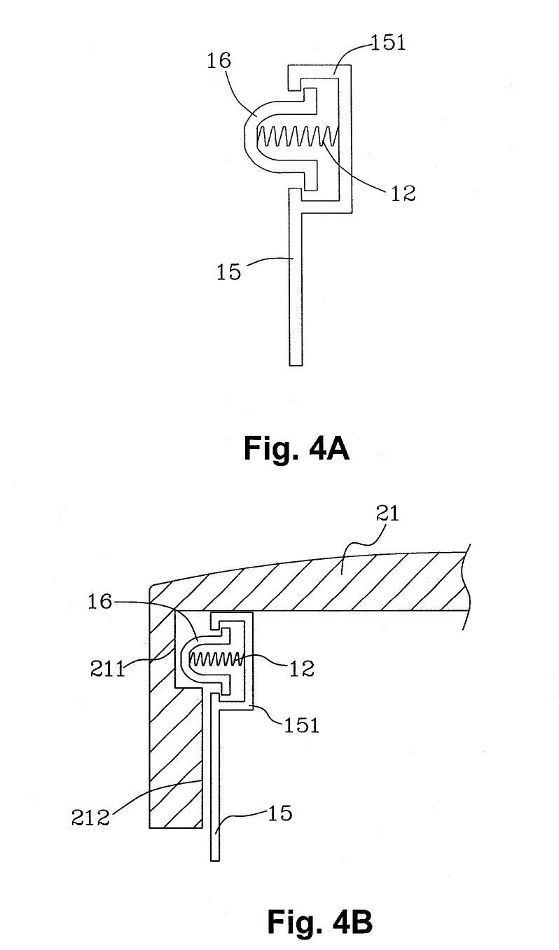

FIG. 4A is a schematic diagram showing locking unit 1 of portable input device 3 in a third exemplary embodiment. Locking unit 1 includes a fixing skeleton 15, an elastic unit 12 and a cap-shaped unit 16. The fixing skeleton 15 is affixed on portable input device 3 and has an accommodation region 151 for receiving elastic unit 12 and cap-shaped unit 16. Cap-shaped unit 16 is movably connected, via elastic unit 12, to the accommodation region 151 of fixing skeleton 15. Elastic unit 12 may be a spring or other biasing device. Elastic unit 12 connects cap-shaped unit 16 and accommodation region 151 in pre-compression state, as shown.

Please refer to FIG. 4B. When a user wants to connect electronic device 2 to portable input device 3, fixing skeleton 15 slides along the guiding surface 212. Cap-shaped unit 16 is pressed by guiding surface 212. Cap-shaped unit 16 is driven into accommodation region 151 during the process. When cap-shaped unit 16 slides into a position corresponding to slot 211, cap-shaped unit 16 is driven into slot 211 by elastic unit 12 such that portable input device 3 remains attached to electronic device 2 during operation.

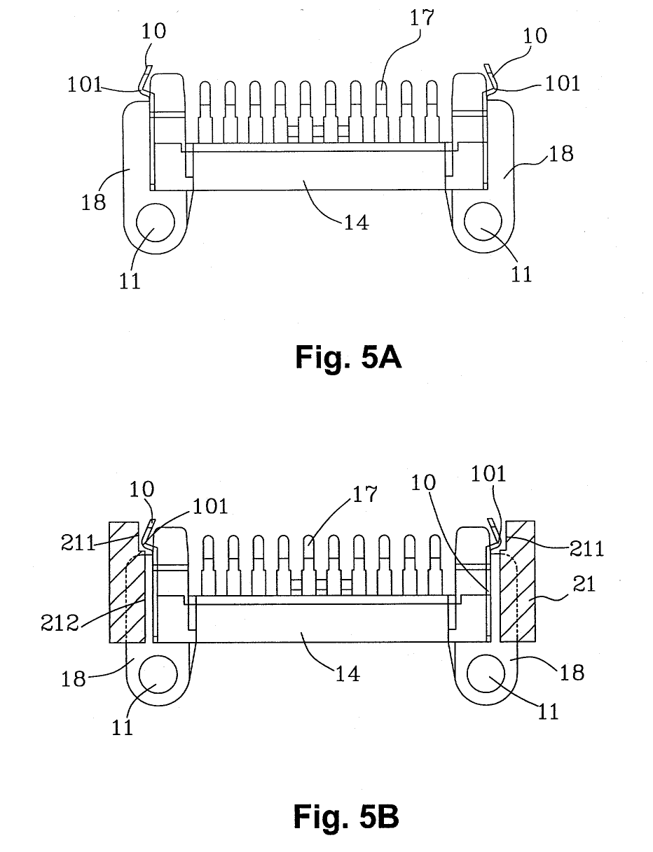

FIG. 5A is a schematic diagram showing locking unit 1 of portable input device 3 in a fourth exemplary embodiment. Locking unit 1 includes latches 10, pivots 11, holders 18, a supporter 14, and a connector 17. Holder 18 connects latches 10 to pivots 11. Connector 17 is used for connecting electronic device 2. Similarly, latches 10 have protrusions 101 respectively, whose shape corresponds to slots 211 shown in FIG. 5B. Parts of latches 10 close to protrusions 101 are made of an elastic material such as deformable plastic. While latches 10 slide along guiding surface 212, protrusions 101 of latches 10 slightly change its shape to mate with the shape of guiding surface 212. After protrusions 101 of latches 10 lock with slots 211, protrusions 101 of latches 10 return to their original shape. Finally, portable input device 3 is locked with electronic device 2. In an exemplary embodiment, latches 10 connect to each other via supporter 14. Supporter 14 is used for maintaining the horizontal distance between latches 10 to prevent latches 10 from detaching from guiding device 21 when they are locked to each other. In this embodiment, connector 17 is disposed on supporter 14 for connecting with electronic devices. When portable input device 3 is connected to electronic device 2, connector 17 is connected to a corresponding socket of electronic device 2.

FIG. 5B is a schematic diagram showing guiding unit 21 and locking unit 1 in a fourth exemplary embodiment. Before electronic device 2 is connected to portable input device 3, locking unit 1 is first aligned to guiding unit 21. Latches 10 are delivered into guiding unit 21 and respectively slide along guiding surfaces 212. Because of the shape of guiding surfaces 212, latches 10 and protrusions 101 are pressed to be closer to each other while sliding along the guiding surface 212. Protrusions 101 of latches 10 are made of an elastic material to slightly change their shape while being pressed by guiding surface 212. As protrusions 101 are pushed to positions corresponding to slots 211, the deformed protrusions 101 return to their original shapes and engage with slots 211 to lock electronic device 2 with portable input device 3.

The exemplary embodiments above illustrate the characters and spirits of the present invention rather than restrict the scope thereof. For example, latches 10 of the locking unit 1 are not only restricted in the shapes shown in the drawings, but any other locking unit that matches with the shape of guiding unit 21 could be used in an alternate embodiment. It is therefore intended that the following appended claims are interpreted as including all such alterations, permutations, and equivalents as falling within the true spirit and scope of the present invention.

1. A portable input device used for lockably connecting to an electronic device, said electronic device having a guiding unit, said guiding unit having at least one slot and at least one guiding surface, said portable input device comprising:
at least one latch disposed on said portable input device, said latch corresponding to said slot;
wherein, when said electronic device connects to said portable input device, said latch slides into said guiding unit along said guiding surface and locks with said slot, such that said electronic device mounts on said portable input device.

2. The portable input device recited in claim 1, wherein said latch connects to an elastic unit, and wherein said elastic unit pushes said latch with a force to slide into said slot along said guiding surface when said latch slides into said guiding unit.

3. The portable input device recited in claim 1, wherein said latch comprises a button for controlling a position of said latch to determine the connection and separation between said latch and said guiding unit.

4. The portable input device recited in claim 1, wherein said portable input device comprises a connector for electronically connecting to said electronic device.

5. The portable input device recited in claim 4, wherein said latch is disposed on said connector.

6. The portable input device recited in claim 1, wherein said portable input device is a portable keyboard.

7. The portable input device recited in claim 1, wherein said electronic device is a personal digital assistant (PDA).

8. The portable input device recited in claim 1, wherein said electronic device is a mobile phone.

9. The portable input device recited in claim 1, wherein the latches are connected to each other by a supporter for maintaining a distance between said two latches.

10. The portable input device recited in claim 4, wherein said latches are connected by a supporter with said connector disposed thereon.

11. The portable input device recited in claim 1, wherein said latch is made of an elastic material.

12. A portable input device used for lockably connecting to an electronic device, said electronic device having a guiding unit with a guiding surface and a slot, said portable input device comprising:
a cap-shaped unit disposed on said input device unit, said cap-shaped unit corresponding to said slot, wherein, when said electronic device connects to said portable input device, said cap-shaped unit slides into said guiding unit along said guiding surface and locks with said slot, such that said electronic device mounts on said portable input device.

13. The portable input device recited in claim 12, wherein said cap-shaped unit connects to an elastic unit, when said cap-shaped unit slides into said guiding unit, said elastic unit provides said cap-shaped unit with a force to slide into said guiding unit.

14. A guiding and locking apparatus for locking an electronic device with a portable input device, comprising:
a guiding unit disposed on said electronic device, said guiding unit having at least one slot and at least one guiding surface; and
a locking unit disposed on said portable input device, said locking unit corresponding to said guiding unit, wherein, when said electronic device connects to said portable input device, said locking unit slides into said guiding unit along said guiding surface and locks with said slot, such that said electronic device mounts on said portable input device.

15. The guiding and locking apparatus recited in claim 14, wherein said locking unit comprises a protrusion corresponding to said slot, wherein said protrusion locks with said slot, such that said electronic device mounts on said portable input device when said locking unit slides into said guiding unit.

16. The guiding and locking apparatus recited in claim 15, wherein said locking unit further comprises an elastic unit, wherein said elastic unit provides said locking unit with a force to slide into said electronic device along said guiding surface when said locking unit slides into said guiding unit.

17. The guiding and locking apparatus recited in claim 16, wherein said locking unit further comprises at least one button for controlling a position of said protrusion to determine the connection and separation between said locking unit and said guiding unit.

18. The guiding and locking apparatus recited in claim 15, wherein said locking unit comprises at least one accommodation region, at least one cap-shaped unit and at least one elastic member, and wherein said cap-shaped unit is flexibly received in said accommodation region by use of said elastic member, and wherein said cap-shaped unit slides into said guiding unit along said guiding surface and locks with said slot when said electronic device is connected to said portable input device.

19. The guiding and locking apparatus recited in claim 14, wherein said portable input device further comprises a connector disposed thereon, said connector corresponding to said electronic device and electrically connecting to said electronic device.

20. The guiding and locking apparatus recited in claim 19 wherein said locking unit is disposed on said connector.
